(19) United States
(12) Patent Application Publication
(10) Pub. No.: US 2002/0022136 A1
(43) Pub. Date: Feb. 21, 2002

(54) Conductive curable composition

(76) Inventors: Joseph A. Valade, Schaghticoke, NY (US); Ned J. Reo, Saratoga Springs, NY (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 09/934,368

(22) Filed: Aug. 21, 2001

Related U.S. Application Data
(60) Provisional application No. 60/227,055, filed on Aug. 21, 2000.

(51) Int. Cl. B32B 9/04; C08G 77/00

(52) U.S. Cl. 428/447; 528/10

(57) ABSTRACT

The present invention is a silicone conductive sponge or foam (open cell) which is arrived at through a two-part addition cured silicone system. When combined with equal parts of “A” and “B”, the system will sponge or foam by heat or at room temperature. A conductive metal is added in concentrations to the system of about 65%-72%, and more preferably in concentrations of 66%-67%. When a sponge sheet stock is formed, the material will sponge 3 to 4 times its original thickness.

### BACKGROUND OF THE INVENTION

1. Field of the Invention

The present invention relates generally to a conductive composition which may be molded to produce electrically conductive articles, such as electromagnetic interference (EMI) and/or radio frequency interference (RFI) shielding. More particularly, the present invention relates to a method of blending curable silicone compositions with metal particulate to form conductive compositions capable of being stored for an indefinite period of time.

2. Background of the Invention

Conductive plastic materials comprising finely divided metal within a plastic matrix have been used to a considerable extent. For example, a heat-shrinkable article comprising a layer of finely divided metal filled plastic is described by Derby, U.S. Pat. No. 3,576,387. The metal filled plastic is used in combination with a heat shrinkable plastic to produce an electromagnetic shield for electrical conductors. Kwong, U.S. Pat. No. 4,695,404, is directed to conductive compositions consisting of a polymeric material filled with from 70 to 90 percent by weight of silver particles.

Cole et al., U.S. Pat. Nos. 5,075,038 and 5,227,093, are directed to electrically conductive silicone compositions comprising a silicone polymer, or an organopolysiloxane convertible to a cured material by reaction with a curing agent, and an amount of silver particles sufficient to render the respective silicone compositions electrically conductive. Kroupa, U.S. Pat. No. 4,929,391, shows that electrically conductive silicone compositions can be made from polydiorganosiloxane and mixtures of silver and conductive carbon particles.

As shown by the art, various blending and molding procedures are available for making shaped articles, such as electromagnetic interference shielding by incorporating a finely divided metal, such as silver, into a plastic or silicone medium. It has been found, however, it is often difficult to produce a molded metal filled plastic product where the metal is substantially uniformly distributed throughout the plastic matrix. As a result, the volume resistivity (ohms-cm) of certain metal filled molded parts may lack uniformity. In addition, molding procedures for fabricating mixtures of plastic blended with large amounts of finely divided metal are often inadequate.

Efforts to improve the molding procedures of certain silicone curable mixtures are shown by Jeram et al., U.S. Pat. No. 3,884,866, and Lee et al., U.S. Pat. No. 4,032,502, which are both incorporated herein by reference. Lee et al., moreover, suggests that liquid injection molding can be used with certain silica filled curable silicone mixtures. In liquid injection molding, a two part mixture, for example, a mixture consisting of a Part A and Part B is often used. Part A can comprise a vinyl terminated polydiorganopolysiloxane fluid in combination with a platinum catalyst and an inhibitor. The curing agent, Part B, is generally a silicone fluid and may comprise a source of dimethylhydrogensiloxane units. The respective parts can be stored indefinitely at ambient temperatures. When mixed, however, the blend can be converted to an elastomeric article if injected into a hot mold.

In the alternative, Takahashi et al., U.S. Pat. Nos. 5,294,373 and 5,482,978, teach the formation of a moldable conductive silicone foam or sponge compositions formed using a peroxide cure system. In particular, an organopolysiloxane material, and a conductive carbon black are combined as a base material. However, a blowing agent and a peroxide and/or platinum catalyst must be added to the base material to cause the composition to foam.

It would be desirable therefor to provide a method for blending particulate silver and a heat curable silicone fluid to produce a substantially uniform mixture suitable for injection molding to fabricate conductive silicone parts. It also would be particularly significant if molded parts fabricated from such mixture of silicone fluid.

There is provided by the present invention, a method for making a substantially uniform blend of conductive metal and a one part heat curable silicone fluid mixture to form a moldable silicone and finely divided metal which exhibits a volume resistivity (ohms-cm) value of about 2 or less. Furthermore, it is desirable to provide a method of forming a moldable conductive silicone foam composition without the need for the addition of a blowing agent and/or a catalyst, as conventionally required.

### SUMMARY OF THE INVENTION

The present invention provides an electrically conductive composition comprising:

a curable silicone, wherein the curable silicone comprises a Theological additive; and

an electrically conductive material, uniformly dispersed in the composition.

A second embodiment of the present invention provides a method for forming an electrically conductive silicone composition comprising:

forming a curable silicone, wherein the curable silicone comprises a rheological additive; and

mixing an electrically conductive material in the composition results in a uniform mixture of the electrically conductive material in the composition.

A third embodiment of the present invention provides a device for use in electromagnetic interference shielding (EMI) comprising:

a shield material including a curable silicone, wherein the curable silicone comprises a Theological additive; and

an electrically conductive material, uniformly dispersed in the composition.

### DETAILED DESCRIPTION OF THE INVENTION

The present invention is a silicone conductive sponge or foam (open cell) which is arrived at through a two-part addition cured silicone system. When combined with equal parts of “A” and “B”, the system will sponge or foam by heat or at room temperature. A conductive metal is added to the system in concentrations of about 65%-72%, and more preferably in concentrations of 66%-67%. When a sponge sheet stock is formed, the material will sponge 3 to 4 times its original thickness.

Part “A” of the system includes:

22 to 32% of vinyl-terninated polyorgano-siloxane;

3 to 20% of vinyl Q Resin Dispersion;

0.38 to 0.52% catalyst;

0.02 to 0.06% inhibitor; and

2 to 8% theological additive.

Part “B” of the system includes:

22 to 32% of vinyl-terminated polyorgano-siloxane;

3 to 20% of vinyl Q Resin dispersion;

3.5 to 10% of methylhydrogensiloxane; and

2 to 8% Theological additive.

Additionally, 63 to 72% metal is added to Parts A and B of the system, wherein Part A and Part B together equal between 28 to 37%, such that when combined with the conductive metal the mixture totals 100%.

The vinyl containing polydiorganopolysiloxane fluid, or “vinylsiloxane” used in the one part heat curable organopolysiloxane fluid mixture of the invention can have a viscosity of from about 100 to 200,000 centipoises at 25° C. and a vinylsiloxy unit content of about 0.03 to about

2.0 mole %. Preferably, the vinylsiloxane is terminated with dimethylvinylsiloxy units and consists essentially of chemically combined dimethylsiloxy units.

However, in some instances, the vinylsiloxane can have vinyl in the backbone such as vinylmethylsiloxy units, or may have chemically combined diorganosiloxy units, or terminal triorganosiloxy units having monovalent radicals such as cyanoethyl, trifluoropropyl, phenyl, or mixtures of such radicals with methyl, or other C₍₁₋₄₎ alkyl radicals. Methods for making the vinylsiloxane fluid can be found in Sumpter et al., U.S. Pat. No. 5,331,075 which is incorporated herein by reference.

The siloxane hydride fluid, or cross linker, can have about 0.04 to about 1.4% by weight of chemically combined hydrogen attached to silicon. One form of the siloxane hydride fluid is a “coupler” having terminal diorganohydrogensiloxy units, where the organo radicals are free of olefinic unsaturation, such as vinyl, and can be selected from C₍₁₋₄₎ alkyl, and preferably methyl, and also include phenyl, cyanoalkyl, and haloaryl. The coupler can have a viscosity of from 1 to 500 centipoises at 25° C. The siloxane hydride fluid also can include silicon hydride resins having terminal diorganohydrogensiloxy units combined with SiO₂ units where the organo+H to Si ratio can vary from 1.0 to 2.7. In addition, the siloxane hydride fluid also can include linear hydride siloxane having a viscosity of 1 to 1000 centpoises at 25° C. Methods for making the siloxane hydride fluid also can be found in the above referenced Sumpter et al. patent.

The catalysts are selected from platinum catalysts which can be used are for example reaction products of an olefin and chloroplatinic acid as shown by Ashby U.S. Pat. No. 3,159,601, or the platinum reaction product with cyclopropane as described by Ashby U.S. Pat. No. 3,159,662. Further examples of platinum catalysts which can be used are shown by Lamoreaux, U.S. Pat. No. 3,220,972. The preferred catalyst is shown by Karstedt, U.S. Pat. No. 3,775,452 formed by reacting chloroplatinic acid and tetramethyldivinyldisiloxane in the presence of sodium bicarbonate in an ethanol solution. Effective cure results of the can be achieved if there is used in the one part heat curable silicone fluid mixture of the present invention, sufficient platinum catalyst to provide from about 1 to about 250 parts of platinum, per million parts of heat curable silicone fluid mixture.

Platinum catalyst inhibitors can be used to extend the pot life of the heat curable silicone fluid mixture. Preferably a dimethyl maleate is used as the inhibitor. Based on the nature and concentration of the inhibitor, cure of the heat curable silicone mixture can be suppressed at 25° C. for an extended period of time. Activation of the platinum catalyst can be effected at an elevated temperature. Certain inhibitors, such as acetylenic alcohols, for example, 2-methyl-3-butyn-2-ol, have been found to require a temperature of 70° C. or above to cure at a practical rate. Additional inhibitors are cyclic methylvinylsiloxanes, allyl maleate and ethyl maleate. Further examples of inhibitors are shown in Kookootsedes et al., U.S. Pat. No. 3,445,420 and Lee et al., U.S. Pat. No. 3,989,667.

Inhibitor concentrations as low as one mole of inhibitor per mole of platinum will sometimes provide a satisfactory work time without interfering with a desired cure rate at an elevated temperature. In other situations, inhibitor concentrations as high as 500 or more moles of inhibitor per mole of platinum may be required.

In addition to platinum inhibitors, one part heat curable organopolysiloxane compositions can be made using a microencapsulated platinum catalyst as shown by Lewis et al., U.S. Pat. No. 5,015,691, incorporated herein by reference. In addition, mixtures of vinyl-substituted organopolysiloxane fluid and a siloxane hydride can be combined with a platinum catalyst to form a part heat curable organopolysiloxane mixture, if the platinum is used as an inclusion compound of a cyclodextrin with a platinum halide complex with a member selected from cyclooctadiene and norbomadiene as shown by Lewis et al., U.S. Pat. No. 5,025,073, incorporated herein by reference.

In the practice of the method of the invention, it is preferred to premix Part A, or the vinyl terminated polydiorganopolysiloxane fluid in combination with a platinum catalyst and inhibitor with Part B, or silicone fluid comprising a source of dimethylhydrogensiloxane units, to form a one part heat curable silicone fluid mixture. The expression “one part heat curable silicone fluid mixture” as used hereinafter in the description of the present invention can include in addition to a blend of Part A and Part B, from up to about 10% of silica filler and optional ingredients such as filler treating agents, flame retardant, pigments and heat stabilizers.

Blending of the silicone fluid with the conductive metal can proceed with a standard means of agitation such as stirring with a spatula, or the use of a mechanical mixer, such as a dough mixer, Banbury mixer, and compounding mills. Loading of the conductive metal occurs until in levels of 63-72% concentration and preferably 66-67% concentration. The two part heat curable silicone fluid mixture can have a viscosity in the range of from about 100 centipoises to about 3500 centipoises at 25° C. After blending with the conductive metal, the viscosity of the blend can increase to 300,000 to 950,000 centipoises. Optionally, this material may be used in Liquid Injection Molding (LIM) applications. LIM pressures can vary between about 5000 psi to about 20,000 psi, and preferably about 10,000 psi to 20,000 psi depending upon the dimensions of the resulting fabricated part. Other forms of molding such as compression molding also has been found to be effective. During the LIM or compression molding operation, curing can be achieved at temperatures in the range of 140° C. to 200° C., and preferably, 150° C. to 160° C.

Conductive metal which can be used in the practice of the invention is available commercially and in the form of solid particles, such as spherical, and most preferably in the form of flakes. The conductive metals include silver powder, silver-plated aluminum, silver plated copper, flake silver plated copper, silver plated glass, silver plated nickel, nickel, nickel graphite and carbon black. The conductive metal can have an average particle size in the range of 0.5 to 100 micrometers.

In order that those skilled in the art will be better able to practice the present invention, the following examples are given by way of illustration and not by way of limitation. All parts are by weight unless otherwise indicated.

### EXAMPLE 1

A heat curable silicone mixture is prepared by blending together the following ingredients. There was blended one part Part A, which includes 40.56 parts of vinyl containing polydimethylsiloxane fluid having a viscosity of 900 to 1100 centipoises at 25° C., 5.0 parts of a vinyl Q resin dispersion with 20-25% Q resin in vinyl-terminated polydimethylsiloxane, 0.4 parts of a platinum catalyst, 0.04 parts of dimethyl maleate (a platinum catalyst inhibitor) and 4.0 parts Thixin R (a Theological additive); with one part Part B, which includes 30 parts of vinyl containing polydimethylsiloxane fluid having a viscosity of 900 to 1100 centipoises at 25° C., 5.0 parts of a vinyl Q resin dispersion with 20-25% Q resin in vinyl-terminated polydimethylsiloxane, 6.0 parts of dimethylsiloxane copolymer 50-55% mole MeHSiO (a clear colorless methylhydrogensiloxane fluid having a viscosity of about 1200 centipoises at 25° C.), 1.0 parts allyltrimethoxysilane (an internal bonding agent), 4.0 parts Thixin R (a rheological additive) and 4.0 parts Tetrakis(Dimethylsiloxy)silane.

An initial blend of 50 parts of the above heat curable silicone mixture and 100 parts of nickel 525 having an average diameter of about 0.5 microns is prepared by adding the nickel 525 to the heat curable silicone mixture while it is stirred in a dough mixer at ambient temperatures. After 5-10 minutes, additional nickel 525 is added while the resulting blend is continuously agitated. The agitation and incorporation of nickel 525 into the resulting heat curable silicone mixture blend is continued for 15-20 minutes until there is obtained a moldable mixture having about 66-67% by weight of nickel 525 and 33-34% by weight of heat curable silicone fluid mixture.

A portion of the curable mixture is molded for about 10 minutes at a temperature of 177° C. to produce a conductive silicone part having a volume resistivity (ohms-cm) value of about 1.0 ohms-cm and a surface volume resistivity of 10.4 ohms-cm, and useful as EMI shielding. It is further found that after a several month shelf period at ambient temperatures, a remaining portion of the moldable mixture also is readily convertible to useful to EMI shielding in accordance with standard injection molding procedures.

### EXAMPLE 2

A heat curable silicone mixture is prepared by blending together the following ingredients. There was blended one part Part A, which includes 40.56 parts of vinyl containing polydimethylsiloxane fluid having a viscosity of 900 to 1100 centipoises at 25° C., 5.0 parts of a vinyl Q resin dispersion with 20-25% Q resin in vinyl-terminated polydimethylsiloxane, 0.4 parts of a platinum catalyst, 0.04 parts of dimethyl maleate (a platinum catalyst inhibitor) and 4.0 parts Thixin R (a Theological additive); with one part Part B, which includes 30 parts of vinyl containing polydimethylsiloxane fluid having a viscosity of 900 to 1100 centipoises at 25° C., 5.0 parts of a vinyl Q resin dispersion with 20-25% Q resin in vinyl-terminated polydimethylsiloxane, 6.0 parts of dimethylsiloxane copolymer 50-55% mole MeHSiO (a clear colorless methylhydrogensiloxane fluid having a viscosity of about 1200 centipoises at 25° C.), 1.0 parts allyltrimethoxysilane (an internal bonding agent), 4.0 parts Thixin R (a rheological additive) and 4.0 parts Tetrakis(Dimethylsiloxy)silane.

An initial blend of 50 parts of the above heat curable silicone mixture and 100 parts of silver-plated copper having an average diameter of about 0.5 microns is prepared by adding the silver-plated copper to the heat curable silicone mixture while it is stirred in a dough mixer at ambient temperatures. After 5-10 minutes, additional silver-plated copper is added while the resulting blend is continuously agitated. The agitation and incorporation of silver-plated copper into the resulting heat curable silicone mixture blend is continued for 15-20 minutes until there is obtained a moldable mixture having about 66-67% by weight of silver-plated copper and 33-34% by weight of heat curable silicone fluid mixture.

A portion of the curable mixture is molded for about 10 minutes at a temperature of 177° C. to produce a conductive silicone part having a volume resistivity (ohms-cm) value of about 0.009 ohms-cm and a surface volume resistivity of 2.0 ohms-cm, and useful as EMI shielding. It is further found that after a several month shelf period at ambient temperatures, a remaining portion of the moldable mixture also is readily convertible to useful to EMI shielding in accordance with standard injection molding procedures.

The silicone conductive sponge or foam when formed includes the following physical properties for all metals:

Compression Deflection: from about 2 to about 5 lbs/square-inch (psi), and more preferably 2 to 3 psi;

Compression set: from about 18 to about 28% for 22 hours at 100 Degrees Celsius and more preferably about 18 to about 20% for 22 hours at 100 Degrees C;

Durometer: Shore “A” from about 22 to about 32, and more preferably a Shore “A” of about 25;

Density: from about 0.6 to about 1.01 lbs/inch-cubed (lbs/in³) and more preferably about 0.8 lbs/in³.

Volume Resistivity: from about 0.009 ohms-cm to 1.0 ohms-cm for all metals except for carbon black, which is 20 ohms-cm to 10,000 ohms-cm.

Trace levels of water, and silicone polymers containing hydroxyl bonded to silicon are known to be present in curable silicones including the curable silicones of the present invention. A preferred level of hydroxyl bonded to silicon for formation of the silicone conductive sponge or foam is an amount to provide a molar ratio of from about 0 to about 5.2 hydroxyl to Si—H. The hydroxyl reacts with Si—H to produce hydrogen gas and silanol. Silanol reacts with a second Si—H to crosslink and produce a second molecule of hydrogen gas. A vinyl addition reaction with siloxane hydride fluids or resins of the present invention will crosslink the composition simultaneously.

Presumably because of the competing reactions: 1) the reaction of Si—H with hydroxyl to produce hydrogen gas to form the sponge; and 2) the crosslinking reaction; a preferred level of hydroxyl bonded to silicon for formation of the silicone conductive sponge or foam is an amount to provide a molar ratio of from about 0 to about 5.2 hydroxyl to Si—H. For embodiments of the present invention in which it is necessary to supplement the level of hydroxyl naturally present in the curable silicone, water, alcohols or silicone polymers containing silanol may be used. Typical sources of silanol are RTV-609, commercially available from the General Electric Company, Silicone Products Division in Waterford, N.Y., and DMS-S31, commercially available from Gelest, Inc., Tullytown. DMS-S31 is a silanol polymer having a nominal viscosity of 1,000 cps at 25° C. and a nominal 0.1% by weight hydroxyl content.

The internal bonding agent is of the form TSi(OR)₃. T represents a monovalent hydrocarbon group having from 1 to 50 carbon atoms selected from the group consisting of vinyl groups, α-alkylvinyl groups, β-alkylvinyl groups, phenylvinyl groups, arylvinyl groups, allyl groups, propargyl groups, alkynl groups and each R independently represents a monovalent hydrocarbon group such as alkyl groups, aryl groups, aralkyl groups, alkaryl groups, cycloalkyl groups, bicycloalkyl groups, alkenyl groups, alkalkenyl groups, and alkenylalkyl groups, alkynyl groups, alkalkynyl groups, alkynylalkyl groups, trifluoropropyl groups, cyanopropyl groups.

The term “alkyl group” designates both normal alkyl and branched alkyl groups. Included among normal and branched alkyl groups are those having between about 1 and about 22 carbon atoms. Normal alkyl and branched alkyl groups include methyl, ethyl, propyl, isopropyl, butyl, tertiary-butyl, pentyl, neopentyl, hexyl, octyl, decyl, dodecyl groups. Aryl groups include phenyl, anthryl and phenanthrylgroups. Included among aralkyl groups are those having between about 7 and about 14 carbon atoms. Aralkyl groups include benzyl, phenylbutyl, phenylpropyl, phenylethyl and phenylallyl groups. Alkaryl groups include tolyl and cumyl groups. Cycloalkyl or bicycloalkyl groups each include between about 3 and about 12 ring carbon atoms, and no greater than about 50 carbon atoms totally. Cycloalkyl groups include cyclobutyl, cyclopentyl, cyclohexyl, methylcyclohexyl, and cycloheptyl groups. Bicycloalkyl groups include norbomyl. Alkenyl groups include ethenyl, butenyl and groups. Alkenylalkyl groups include allyl groups. Alkylalkenyl groups include 4-methyl-3-butenyl. Alkenylphenyl groups include vinylphenyl groups. Arylalkenyl groups include styryl groups. Alkynyl groups include ethynyl goups. Alkynylalkyl groups include propargyl groups. Alkylalkynyl groups include 4-methyl-3-butynyl groups.

1. An electrically conductive composition comprising:
a curable silicone, wherein the curable silicone comprises a rheological additive; and
an electrically conductive material, uniformly dispersed in the composition.

2. The composition of claim 1 comprising 100 parts of a mixture formed by mixing:
28 to 37 parts of the curable silicone comprising:
70.56 parts of a vinylsiloxane having a vinylsiloxy unit content from about 0.03 to about 2.0 mole % is selected from the group consisting of vinylsiloxanes having a viscosity of from about 100 to about 200,000 cps at 25° C. and a vinyl Q resin dispersion, wherein the vinylsiloxy unit is selected from the group consisting of on-backbone organovinylsiloxy units, terminal diorganovinylsiloxy units and combinations thereof; and wherein the organo radicals are selected from the group consisting of cyanoethyl, trifluoropropyl, phenyl, methyl, monovalent C₍₁₋₄₎ alkyl radicals and mixtures thereof.
10.0 parts of a vinyl Q resin dispersion;
1 to 250 parts of Pt per million parts of curable silicone;
1 to 500 parts of a cure inhibitor per part of Pt; and
6.0 parts of a siloxane hydride fluid containing from about 0.4 to about 1.4% by weight hydrogen as Si—H groups, wherein the siloxane hydride fluid is selected from the group consisting of a coupler having a terminal diorganohydrogensiloxy unit, a silicone hydride resin having a terminal diorganohydrogensiloxy unit combined with an SiO₂ unit where an (organo+H) to Si ratio includes from about 1.0 to about 2.7, wherein a viscosity of the coupler includes from about 1 to about 500 cps at 25° C., wherein a viscosity of the linear hydride siloxane includes from about 1 to 1200 cps at 25° C., wherein the organo radicals of the diorganohydrogensiloxy units are selected from the group consisting of cyanoalkyl, haloaryl, phenyl, methyl, monovalent C₍₁₋₄₎ alkyl and mixtures thereof;
8.0 parts of a Thixin-R; and
63 to 72 parts of the electrically conductive material.

3. The composition of claim 1, wherein an amount of the Theological additive includes from about 0 to about 8% by weight.

4. The composition of claim 1, the curable silicone further comprising an internal bonding agent having a formula: TSi(OR)₃;
wherein T represents a monovalent hydrocarbon group having from 1 to 50 carbon atoms selected from the group consisting of vinyl groups, α-alkylvinyl groups, β-alkylvinyl groups, phenylvinyl groups, arylvinyl groups, allyl groups, propargyl groups, alkynl groups and each R independently represents a monovalent hydrocarbon group having from 1 to 50 carbon atoms selected from the group consisting of alkyl groups, aryl groups, aralkyl groups, alkaryl groups, cycloalkyl groups, bicycloalkyl groups, alkenyl groups, alkalkenyl groups, and alkenylalkyl groups, alkynyl groups, alkalkynyl groups, alkynylalkyl groups, trifluoropropyl groups, cyanopropyl groups, acryloyl groups, arylacryloyl groups, acryloylaryl groups, alkylacyl groups, arylacyl groups alkylenylacyl groups and alkynylacyl groups and combinations thereof,
wherein each alkyl group includes linear and branched alkyl groups selected from the group consisting of methyl groups, ethyl groups, propyl groups, butyl groups, pentyl groups, hexyl groups, heptyl groups, octyl groups, nonyl groups, decyl groups, isopropyl groups, isobutyl groups, 2-butyl groups, t-butylgroups, isopentyl groups, 2-methylbutyl groups, neopentyl groups 2-methylpentyl groups, 3-methylpentyl groups, 1,1-dimethylbutyl groups, 2,2-dimethylbutyl groups, 3,3-dimethylbutyl groups, 4,4-dimethylbutyl groups, 1,3-dimethylbutyl groups, and combinations thereof;
wherein aryl groups include phenyl, anthryl and phenanthryl groups;
wherein aralkyl groups include benzyl, phenylbutyl, phenylpropyl, phenylethyl and phenylallyl groups having between 7 and 14 carbon atoms;
wherein alkaryl groups include tolyl and cumyl groups;
wherein cycloalkyl groups include cyclobutyl groups, cyclopentyl groups, cyclohexyl groups, methylcyclohexyl groups groups, and cycloheptyl groups having between about 3 and about 12 ring carbon atoms, and no greater than about 50 carbon atoms and bicycloalkyl groups include norbornyl groups having between about 3 and about 12 ring carbon atoms, and no greater than about 50 carbon atoms;
wherein alkenyl groups include ethenyl and butenyl groups;
wherein alkenylalkyl groups include allyl groups;
wherein alkylalkenyl groups include 4-methyl-3-butenyl;
wherein alkenylphenyl groups include vinylphenyl groups;
wherein arylalkenyl groups include styryl groups;
wherein alkynyl groups include ethynyl goups;
wherein alkynylalkyl groups include propargyl groups.
wherein alkylalkynyl groups include 4-methyl-3-butynyl groups; and
wherein an amount of the internal bonding agent provides a molar ratio of from about 0 to about 10.0 (OR) from the formula to Si—H from a siloxane hydride fluid in the curable silicone.

5. The composition of claim 1, the curable silicone further comprising allyltrimethoxysilane.

6. The composition of claim 1, the curable silicone further comprising a silicone hydride monomer in an amount to provide a molar ratio of from about 0 to about 1.0 Si—H from the silicon hydride monomer to Si—H from a siloxane hydride fluid.

7. The composition of claim 6, wherein the silicone hydride monomer includes tetrakis(dimethylsiloxy)silane.

8. The composition of claim 1, wherein the curable silicone further comprises an additive selected from the group consisting of water, organic alcohol, silanol and combinations thereof, in an amount to provide a molar ratio of from about 0 to about 5.2 hydroxyl to Si—H.

9. The composition of claim 1, wherein the electrically conductive material is selected from the group consisting of silver powder, silver-plated aluminum, silver plated copper, flake silver plated copper, silver plated glass, silver plated nickel, nickel, nickel graphite and carbon black.

10. The composition of claim 1, wherein an average particle size of the conductive material includes from about 0.5 to 100 micrometers.

11. The composition of claim 1, the curable silicone further comprising a cure inhibitor selected from the group consisting of dialkyl maleate, acetylenic alcohol, cyclic and linear methylvinylsiloxane and combinations thereof.

12. The composition of claim 11, wherein the cure inhibitor is selected from the group consisting of dimethylmaleate, allyl maleate, divinyltetramethyldisiloxane, 2-methyl-3-butyn-2-ol and combinations thereof.

13. The composition of claim 1, wherein the curable silicone composition includes an electrically conductive silicone conductive sponge having the following physical properties for all metals:
Compression Deflection: from about 2 to about 5 lbs/square-inch (psi), and more preferably 2 to 3 psi;
Compression set: from about 18 to about 28% for 22 hours at 100 Degrees Celsius and more preferably about 18 to about 20% for 22 hours at 100 Degrees C;
Durometer: Shore “A” from about 22 to about 32, and more preferably a Shore “A” of about 25;
Density: from about 0.6 to about 1.01 lbs/inch-cubed (lbs/in³) and more preferably about 0.8 lbs/in³.
Volume Resistivity: from about 0.009 ohms-cm to 1.0 ohms-cm for all metals except for carbon black, which is 20 ohms-cm to 10,000 ohms-cm.

14. The composition of claim 1, wherein the curable silicone further comprises from about 0 to about 10% by weight additives selected from the group consisting of silica filler, filler treating agents, flame retardants, pigments, heat stabilizers and combinations thereof.

15. A method for forming an electrically conductive silicone composition comprising:
forming a curable silicone, wherein the curable silicone comprises a rheological additive; and
mixing an electrically conductive material in the composition results in a uniform mixture of the electrically conductive material in the composition.

16. The method of claim 15 comprising:
forming 100 parts of a mixture by mixing:
28 to 37 parts of the curable silicone comprising:
70.56 parts of a vinyl siloxane having a vinylsiloxy unit content from about 0.03 to about 2.0 mole % is selected from the group consisting of vinylsiloxanes having a viscosity of from about 100 to about 200,000 cps at 25° C. and vinyl Q resin dispersion, wherein the vinylsiloxy unit is selected from the group consisting of on-chain organovinylsiloxy units, terminal diorganovinylsiloxy units and combinations thereof; and wherein the organo radicals are selected from the group consisting of cyanoethyl, trifluoropropyl, phenyl, methyl, monovalent C₍₁₋₄₎ alkyl radicals and mixtures thereof.
10.0 parts of a vinyl Q resin dispersion;
1 to 250 parts of Pt per million parts of curable silicone;
1 to 500 parts of a cure inhibitor per part of Pt; and
6.0 parts of a siloxane hydride fluid containing from about 0.4 to about 1.4% by weight hydrogen as Si—H groups, wherein the siloxane hydride fluid is selected from the group consisting of a coupler having a terminal diorganohydrogensiloxy unit, a silicone hydride resin having a terminal diorganohydrogensiloxy unit combined with an SiO₂ unit where an (organo+H) to Si ratio includes from about 1.0 to about 2.7, wherein a viscosity of the coupler includes from about 1 to about 500 cps at 25° C., wherein a viscosity of the linear hydride siloxane includes from about 1 to 1200 cps at 25° C., wherein the organo radicals of the diorganohydrogensiloxy units are selected from the group consisting of cyanoalkyl, haloaryl, phenyl, methyl, monovalent C₍₁₋₄₎ alkyl and mixtures thereof;
8.0 parts of Thixin-R; and
63 to 72 parts of the electrically conductive material.

17. The method of claim 15, wherein an amount of the Theological additive includes from about 0 to about 8% by weight.

18. The method of claim 15, the curable silicone further comprising an internal bonding agent having a formula: TSi(OR)₃;
wherein T represents a monovalent hydrocarbon group having from 1 to 50 carbon atoms selected from the group consisting of vinyl groups, α-alkylvinyl groups, β-alkylvinyl groups, phenylvinyl groups, arylvinyl groups, allyl groups, propargyl groups, alkynl groups and each R independently represents a monovalent hydrocarbon group having from 1 to 50 carbon atoms selected from the group consisting of alkyl groups, aryl groups, aralkyl groups, alkaryl groups, cycloalkyl groups, bicycloalkyl groups, alkenyl groups, alkalkenyl groups, and alkenylalkyl groups, alkynyl groups, alkalkynyl groups, alkynylalkyl groups, trifluoropropyl groups, cyanopropyl groups, acryloyl groups, arylacryloyl groups, acryloylaryl groups, alkylacyl groups, arylacyl groups alkylenylacyl groups and alkynylacyl groups and combinations thereof;
wherein each alkyl group includes linear and branched alkyl groups selected from the group consisting of methyl groups, ethyl groups, propyl groups, butyl groups, pentyl groups, hexyl groups, heptyl groups, octyl groups, nonyl groups, decyl groups, isopropyl groups, isobutyl groups, 2-butyl groups, t-butylgroups, isopentyl groups, 2-methylbutyl groups, neopentyl groups 2-methylpentyl groups, 3-methylpentyl groups, 1,1-dimethylbutyl groups, 2,2-dimethylbutyl groups, 3,3-dimethylbutyl groups, 4,4-dimethylbutyl groups, 1,3-dimethylbutyl groups, and combinations thereof;
wherein aryl groups include phenyl, anthryl and phenanthryLgroups;
wherein aralkyl groups include benzyl, phenylbutyl, phenylpropyl, phenylethyl and phenylallyl groups having between 7 and 14 carbon atoms;
wherein alkaryl groups include tolyl and cumyl groups;
wherein cycloalkyl groups include cyclobutyl groups, cyclopentyl groups, cyclohexyl groups, methylcyclohexyl groups groups, and cycloheptyl groups having between about 3 and about 12 ring carbon atoms, and no greater than about 50 carbon atoms and bicycloalkyl groups include norbornyl groups having between about 3 and about 12 ring carbon atoms, and no greater than about 50 carbon atoms;
wherein alkenyl groups include ethenyl and butenyl groups;
wherein alkenylalkyl groups include allyl groups;
wherein alkylalkenyl groups include 4-methyl-3-butenyl;
wherein alkenylphenyl groups include vinylphenyl groups;
wherein arylalkenyl groups include styryl groups;
wherein alkynyl groups include ethynyl goups;
wherein alkynylalkyl groups include propargyl groups.
wherein alkylalkynyl groups include 4-methyl-3-butynyl groups; and
wherein an amount of the internal bonding agent provides a molar ratio of from about 0 to about 10.0 (OR) from the formula to Si—H from a siloxane hydride fluid in the curable silicone.

19. The method of claim 18, further comprising a curable silicone that includes allyltrimethoxysilane.

20. The method of claim 15, the curable silicone further comprising a silicone hydride monomer in an amount to provide a molar ratio of from about 0 to about 1.0 Si—H from the silicon hydride monomer to Si—H from a siloxane hydride fluid.

21. The method of claim 20, wherein the silicone hydride monomer includes tetrakis(dimethylsiloxy)silane.

22. The method of claim 15, wherein the electrically conductive material is selected from the group consisting of silver powder, silver-plated aluminum, silver plated copper, flake silver plated copper, silver plated glass, silver plated nickel, nickel, nickel graphite and carbon black.

23. The method of claim 15, wherein an average particle size of the conductive material includes from about 0.5 to 100 micrometers.

24. The method of claim 15, further comprising a cure inhibitor selected from the group consisting of dialkyl maleate, acetylenic alcohol, cyclic and linear methylvinylsiloxane.

25. The method of claim 24, wherein the cure inhibitor is selected from the group consisting of dimethylmaleate, allyl maleate, 2-methyl-3-butyn-2-ol, divinyltetramethyldisiloxane and combinations thereof.

26. The method of claim 15, wherein the curable silicone further comprises from about 0 to about 10% by weight additives selected from the group consisting of silica filler, filler treating agents, flame retardants, pigments, heat stabilizers and combinations thereof.

27. A device for use in electromagnetic interference shielding (EMI) comprising:
a shield material including a curable silicone, wherein the curable silicone comprises a rheological additive; and
an electrically conductive material, uniformly dispersed in the composition.
